(19) United States
(12) Patent Application Publication
(10) Pub. No.: US 2023/0022718 A1
(43) Pub. Date: Jan. 26, 2023

(54) WIND TURBINE AND POWER TRANSMISSION SYSTEM FOR SUCH

(71) Applicant: Vestas Wind Systems A/S, Aarhus N (DK)

(72) Inventor: Andreas Enting, Frondenberg (DE)

(21) Appl. No.: 17/781,884

(22) PCT Filed: Dec. 14, 2020
(86) PCT No.: PCT/DK2020/050362

§ 371 Date: Jun. 2, 2022

(30) Foreign Application Priority Data
Dec. 17, 2019 (DK) PA 2019 70782

(51) Int. Cl. F03D 15/00

(52) U.S. Cl. CPC F03D 15/00; F05B 2260/40311; F05B 2260/301

(57) ABSTRACT

The invention relates to a wind turbine comprising a hub, a nacelle, a tower and a power transmission system for increasing the rotational speed from said hub, said power transmission system comprising at least a first and a second epicyclic gear stage, each of said epicyclic gear stages including a ring gear, a planet carrier and a plurality of planet gears, said plurality of planet gears being mounted in the planet carrier and engaging with the ring gear and with a sun gear; wherein each of said plurality of planet gears of at least said first epicyclic gear stage and said second epicyclic gear stage have identical gear profile design parameters.

### FIELD OF THE INVENTION

The present invention relates to power transmission systems. More specifically, the present invention relates to power transmission systems for wind turbines.

### BACKGROUND OF THE INVENTION

Wind turbines typically include a rotor with large blades driven by the wind. The blades convert the kinetic energy of the wind into rotational mechanical energy. The mechanical energy usually drives one or more generators to produce electrical power. Thus, wind turbines include a power transmission system to process and convert the rotational mechanical energy into electrical energy. The power transmission system is sometimes referred to as the “power train” of the wind turbine. The portion of a power transmission system from the rotor to the generator is referred to as the drivetrain.

Oftentimes it is necessary to increase the rotational speed of the rotor to the speed required by the generator(s). This is accomplished by a gearbox between the rotor and generator. Thus, the gearbox forms part of the power train and converts a low-speed, high-torque input from the rotor into a lower-torque, higher-speed output for the generator.

Because of the limited space in the nacelle and in order to minimize the weight of the nacelle, the preferred gearbox type in most modern wind turbines is an epicyclical gearbox. Recently, it has also been seen to introduce first and second epicyclic gear stages, with the first stage being capable of handling a very high torque level coming from the rotor and transforming the rotational energy into a decreased torque level at increased speed, and the second stage being designed to handle this decreased torque level and transforming the rotational energy into an even higher rpm speed.

The present invention seeks to improve gearboxes for wind turbines comprising at least two epicyclic planet gear stages.

### SUMMARY OF THE INVENTION

The invention relates to a wind turbine comprising a hub, a nacelle, a tower and a power transmission system for increasing the rotational speed from said hub, said power transmission system comprising at least a first and a second epicyclic gear stage, each of said epicyclic gear stages including a ring gear, a planet carrier and a plurality of planet gears, said plurality of planet gears being mounted in the planet carrier and engaging with the ring gear and with a sun gear; wherein each of said plurality of planet gears of at least said first epicyclic gear stage and said second epicyclic gear stage are identical in all of the following gear profile design parameters:

mₙ (normal module), αₙ (normal pressure angle), β (helix angle at pitch diameter), z_{P} (number of teeth), x (profile shift coefficient), x_{E} (generating profile shift coefficient), and h_{aP0}* (addendum coefficient factor of generating rack).

The above parameters are standard parameters for skilled persons working within gears and are considered the basic parameters. Based on these parameters a large number of other parameters can be calculated for the individual gears, as can be seen for instance in DIN3998 or the book Stirnradverzahnung by Heinz Linke, 1996 Carl Hanser Verlag München Wien.

The invention further relates to a wind turbine comprising a hub, a nacelle, a tower and a power transmission system for increasing the rotational speed from said hub, comprising at least a first and a second epicyclic gear stage, each of said epicyclic gear stages including a ring gear, a planet carrier and a plurality of planet gears, said plurality of planet gears being mounted in the planet carrier and engaging with the ring gear and with a sun gear; wherein each of said plurality of planet gears of at least said first epicyclic gear stage and said second epicyclic gear stage are identical with respect to normal section profile, identical transverse section profile, and diameters.

The terms ‘normal section profile’ and ‘transverse section profile’ are standard terms for skilled persons working within gears. A normal section profile is a profile as seen perpendicular to a center axis of a tooth, whereas a transverse section profile is a profile as seen perpendicular to the rotational axis of the gear. This means that for helical gears, these two profiles are different, whereas they will be identical for spur gears. A clear understanding of this can be obtained e.g. from DIN3998 part 1, 1.2.3.4 and 1.2.3.5. With the term ‘diameters’ here is meant all different diameters as seen in a cross-section of the gear, in particular the tip diameter, dₐ, the form diameter of dedendum, d_{Ff}, and the root diameter d_{f} (see FIG. 9).

In an embodiment of the invention, each of said plurality of planet gears of said first epicyclic gear stage are identical in all parameters, and each of said plurality of planet gears of said second epicyclic gear stage are identical in all parameters, wherein the axial width of planet gears of said first epicyclic gear stage are different from the axial width of planet gears of said second epicyclic gear stage. With all parameters being identical except for the axial width of the planet gears, all complicated steps when it comes to manufacturing of the planet gears are identical. The same tools can be used, and the only difference is which axial width of the planet gear is required, which is a simple step compared to the manufacturing of the teeth. Hence, the manufacturing of the planet gears is much simplified compared to prior art gearboxes.

In an embodiment of the invention, each of said plurality of planet gears of at least said first epicyclic gear stage and said second epicyclic gear stage are identical in all parameters. With all planet gears being exactly identical in all ways, including axial width, it brings the advantage of increasing the similarity in different gear stages and reduce the number of different parts in the power transmission.

In an embodiment of the invention, all planet gears of each epicyclic gear stage has a ratio of b_{Disc}/d≤0.3, wherein ‘b_{Disc}’ is the axial width of each individual planet gear and ‘d’ is the standard pitch diameter of the planet gear. It is noted that b=b_{Disc}*N, where N is the number of planet gears combined (stacked) into a common planet gear. This means that for embodiments where N=1, b=b_{Disc}.

In an embodiment of the invention, the sun gear of said first epicyclic gear stage is different from the sun gear of said second epicyclic gear stage.

Having different sun gears is preferred over different planet gears, as each gear stage has only a single sun gear.

In an embodiment of the invention, the sun gear of said first epicyclic gear stage is different from the sun gear of said second epicyclic gear stage by having a larger diameter, such as at least 10% higher diameter. One example of having different sun gears is by having different diameters. As an example, the sun gear of the first gear stage may be larger than the sun gear of the second gear stage by at least 10%, or at least 20%, such as at least 30% or at least 50%. Obviously, it could equally well be the second gear stage in which the sun gear is the largest by these amounts.

In an embodiment of the invention, the sun gear of said first epicyclic gear stage is different from the sun gear of said second epicyclic gear stage by having a larger axial width, such as at least 10% larger axial width.

Another example of having different sun gears is by having a larger axial width. As an example, the sun gear of the first gear stage may be larger in width than the sun gear of the second stage by at least 10%, or at least 20%, such as at least 30% or at least 50%. Obviously, it could equally well be the second gear stage in which the sun gear is the largest by these amounts.

In an embodiment of the invention, said power transmission system further comprises a third epicyclic gear stage including a ring gear, a planet carrier and a plurality of planet gears, said plurality of planet gears being mounted in the planet carrier and engaging with the ring gear and with a sun gear. The present invention is in particular believed to find its value in multiple epicyclic stage gearboxes, as the above-mentioned tooling and servicing features are more valuable for a higher number of equal planet gears. Hence, gearboxes including at least 3, at least 4, at least 5 or even at least 6 or at least 7 epicyclic stages are also within the scope of the present invention.

In an embodiment of the invention, said power transmission system further comprises a fourth epicyclic gear stage including a ring gear, a planet carrier and a plurality of planet gears, said plurality of planet gears being mounted in the planet carrier and engaging with the ring gear and with a sun gear.

In an embodiment of the invention, at least one of said epicyclic gear stages includes between 3 and 12 planet gears, preferably between 3 and 9. The number of planet gears in each epicyclic gear stage can be adjusted as required. Each planet stage may comprise between 2 and 12 planet gears. For instance, a first stage could have between 5 and 12, a second stage could have been 4 and 9, a third stage could have between 3 and 8.

In an embodiment of the invention, all planet gears in at least two gear stages comprises helical gears. Spur gears and helical gears are normally chosen based on a desired design. Helical gears have an advantage in respect of noise and tonality aspects, therefore helical gears are most often preferred but in other embodiments, all planet gears in at least two gear stages could also comprise spur gears.

In an embodiment of the invention, for said at least first and said at least second epicyclic gear stage the quotient X is the same, X being the sum of the absolute tooth number z_{S} of said sun gear and z_{RG} of said ring gear divided by the number of planet gears N in said epicyclic gear stage (X=(|z_{S}|+|z_{RG}|)/N). In an embodiment of the invention, the quotient X has a value between 13 and 33, such as between 15 and 25.

In an embodiment of the invention, said number of planet gears in said at least first and said at least second epicyclic gear stage is different. For instance, it could be one or two higher in said first gear stage than in the second. Having a different number of planet gears in neighbouring gear stages may be beneficial with respect to vibration and/or noise.

In an embodiment of the invention, each of said epicyclic gear stages comprises at least 5 planet gears.

In an embodiment of the invention, each of said plurality of planet gears of at least said first epicyclic gear stage and said second epicyclic gear stage has a number of gear teeth z_{P} between 20 and 40. For instance it could be between 25 and 35.

In an embodiment of the invention, the power transmission system further comprises a main shaft configured to be driven by the rotor about a main axis; a support structure including at least one bearing supporting the main shaft for rotation about the main axis and constraining other movements; wherein each of said epicyclic gear stages are part of a gearbox, wherein said gearbox has a gearbox housing rigidly coupled to the support structure and an input member coupled to the main shaft.

In an embodiment of the invention, the support structure further includes a bearing housing surrounding the at least one bearing, the gearbox housing being suspended from the bearing housing.

In an embodiment of the invention, the power transmission system further comprises a generator having a rotor and stator positioned within a generator housing, the generator housing being rigidly coupled to and suspended from the gearbox housing.

In an embodiment of the invention, the at least one bearing comprises a first bearing and a second bearing spaced apart within the bearing housing.

In an embodiment of the invention, said planet carrier of said first epicyclic gear stage is connected to said main shaft.

In an embodiment of the invention, a planet carrier of said second epicyclic gear stage is connected to said sun gear of said first epicyclic gear stage.

In an embodiment of the invention, said gearbox is rigidly coupled to said support structure through a connection comprising a plurality of bolts installed in corresponding bolt holes of the gearbox and the support structure, and a plurality of dowel pins installed in corresponding dowel pin holes of the gearbox and the support structure, the dowel pins having been installed in the dowel pin holes by shrink fitting. In an embodiment of the invention, the shrink fitting comprises cooling the dowel pins.

The invention further relates to a set of wind turbines comprising at least a first wind turbine with a first size gearbox and a second wind turbine with a second size gearbox, wherein said first size gearbox and said second size gearbox are different, and wherein each of said planet gears of said first size gearbox and said second size gearbox are identical with respect to normal section profile, identical transverse section profile, and diameters. It is considered highly beneficial at least cost-wise to have identical planet gears throughout a series of gearboxes of different sizes, regardless of which planet stage or which turbine.

In an embodiment of the invention, said set of wind turbines comprises at least 3 different gearbox sizes, such as between 4 and 20, wherein each of said planet gears of said at least 3 different gearbox sizes are identical with respect to normal section profile, identical transverse section profile, and diameters.

In an embodiment of the invention, said first size gearbox comprises at least 5 planet gears in said first epicyclic gear stage and at least 4 planet gears in said second epicyclic gear stage, and said second size gearbox comprises at least 6 planet gears in said first epicyclic gear stage and at least 5 planet gears in said second epicyclic gear stage.

In an embodiment of the invention, each size of gearbox has at least 3 epicyclic gear stages (GP≥3), such as between 3 and 8.

In an embodiment of the invention, each size of gearbox has at least 1 epicyclic gear stage (GP≥1) with at least 5 planet gears, such as between 5 and 15.

### BRIEF DESCRIPTION OF THE DRAWINGS

The above and other aspects of the invention will now be described, by way of example only, with reference to the accompanying drawings, in which:

FIG. 1 is a perspective view of one example of a wind turbine,

FIG. 2 is a perspective view of a prior art power transmission system for the wind turbine of FIG. 1,

FIG. 3 is a cross-sectional view of the prior art power transmission system of FIG. 2,

FIG. 4 is a perspective view of a planetary gear set, including a planet carrier,

FIG. 5-7 are perspective views of a three-stage gearbox according to three embodiments of the invention,

FIG. 8 is an illustration of a single planet gear for illustration, and

FIG. 9 is an illustration of a single teeth of a planet gear for illustration.

Note that features that are the same or similar in different drawings are denoted by like reference signs.

### DETAILED DESCRIPTION OF THE DRAWINGS

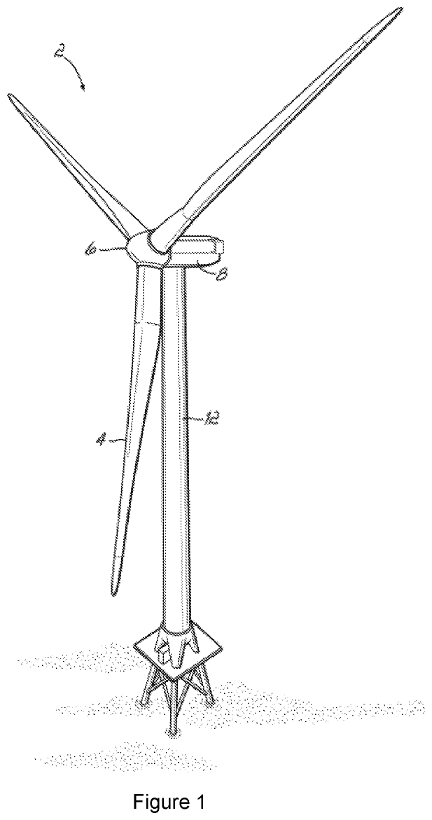

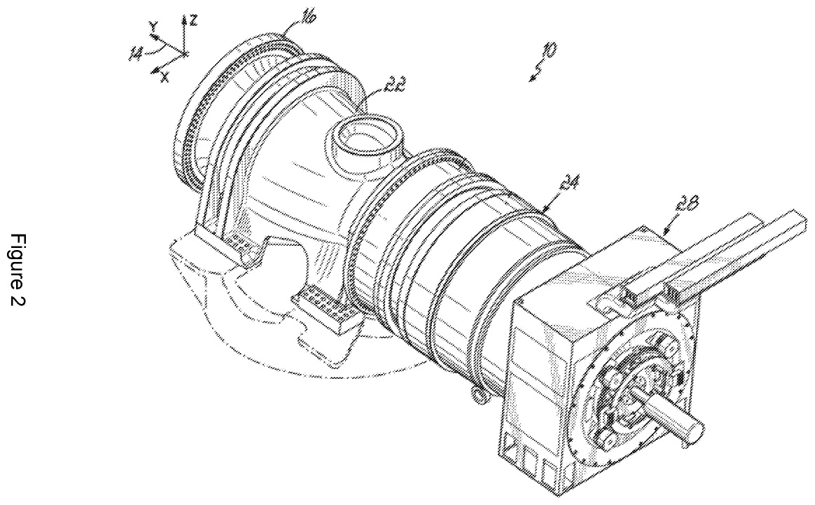

FIG. 1 shows one example of a wind turbine 2. Although an offshore wind turbine is shown, it should be noted that the description below may be applicable to other types of wind turbines as well. The wind turbine 2 includes rotor blades 4 mounted to a hub 6, which is supported by a nacelle 8 on a tower 12. Wind causes the rotor blades 6 and hub 6 to rotate about a main axis 14 (FIG. 2). This rotational energy is delivered to a power transmission system (or “power train”) 10 housed within the nacelle 8.

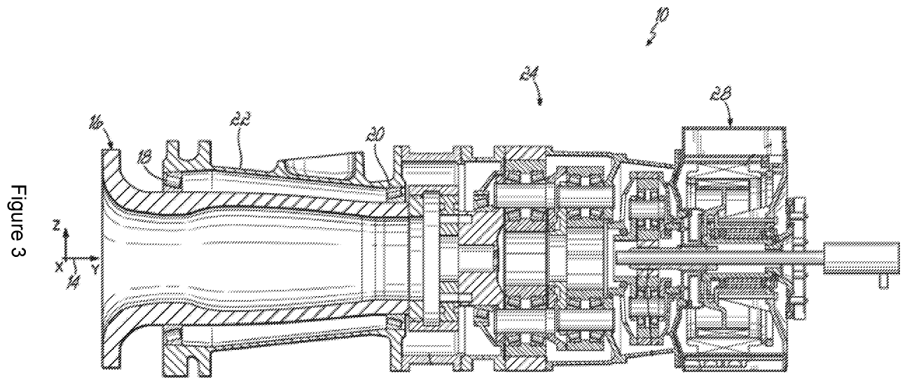

As shown in FIGS. 2 and 3, a power transmission system 10 includes a main shaft 16 coupled to the hub 6 (FIG. 1). The power transmission system 10 also includes first and second bearings 18, 20 supporting the main shaft 16, a bearing housing 22 surrounding the first and second bearings 18, 20, and a gearbox 24 having an input member 26 driven by the main shaft 16. The gearbox 24 increases the rotational speed of the main shaft 16 to drive a generator 28. The bearing housing 22 and the gearbox 24 is connected with bolts and optionally also with dowel pins.

It will be convenient to make reference to a three-dimensional coordinate system based upon the main axis 14. In this coordinate system, the y-axis is considered to be the main axis of the system, also labeled as the axial direction. The x-axis and z-axis are perpendicular to the y-axis, with the z-axis being generally aligned with the gravitational direction.

The type of input member 26 depends on the particular gearbox design. Shown is the use of a planet carrier of the first planetary stage, wherein the ring gear is fixed to the housing, which results in the sun gear increasing the rotational speed to transfer to the next stage of the gearbox.

Within the scope of the invention any gearbox design suitable for wind turbines including at least two epicyclic gear stages may be used, including differential designs as shown in FIG. 3. FIG. 3 shows a first A, a second B and a third C planetary stage. As can be seen, the size of the different stages varies as a requirement to cope with the necessary torque in the individual stages. Consequently, the individual stages require different sizes of gears.

Each stage of an epicyclic gear comprises one ring gear and one sun gear, whereas the number of planet gears may vary. A typical number is 3, but it can be much higher dependent on how much torque transfer is needed. This means that for a gearbox as shown in FIG. 3, for example the first stage A could include 9 planet gears, the second stage B could include 6 planet gears and the third stage C could include 3 planet gears. In total this would amount to 18 planet gears in a single gearbox. With different sizes of the individual stages, this would require manufacturing 18 planet gears in three different sizes, i.e. with three different gear profile designs.

It is believed that it would be highly beneficial to have multiple-stage epicyclic gearboxes comprising planet gears of one and only one gear profile design. When having just a single gear profile design, it is easier to manufacture the gears by the use of the same tool to create the identical tooth profiles and sizes. Further, when doing service on the gearbox, if replacement of a planet gear is required, the service technician will only need to bring one type of planet gears, regardless of which epicyclic gear stage possesses the problem.

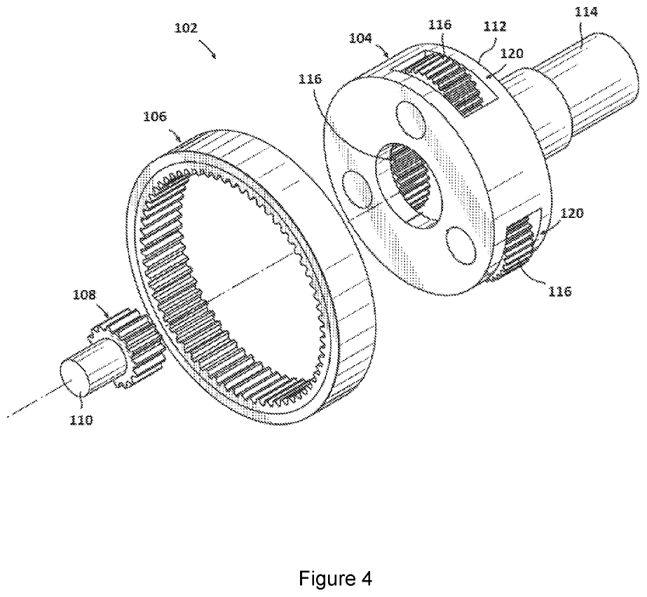

With reference to FIG. 4, an example of a single epicyclic gear stage 102 is shown for context for the present invention. It includes a planet carrier 104, a ring gear 106 and a sun gear 108 including a shaft 110. As FIG. 4 is an exploded view of the epicyclic gear stage 102, the sun gear 108 is shown spaced from the planet carrier 104. However, in practice the sun gear 108 would be positioned in the centre of the planet carrier 104.

The planet carrier 104 comprises a carrier 112 that is generally annular in form and which is coupled to or integrated with an input shaft 114. Although not shown, the input shaft 114 would be connected to a suitable driven load and, similarly, the output shaft 110 of the sun gear 108 would be coupled to a suitable prime mover. Both the load and the prime mover are not shown here for simplicity. Also, note that although the terms ‘input’ and Output’ have been used for the two shafts, this is for convention only and does not imply a limitation on the functionality of the respective shafts. The planet carrier 104 is formed as a generally hollow body defining opposed plate-like structures that support a plurality of planet gears 116. In FIG. 4 the epicyclic gear stage 102 includes three planet gears 116. As is clear from the following description, it should be noted that epicyclic gear stages 102 may also have more or fewer than three planet gears. This invention applies to all such configurations.

It should be appreciated at this point that the epicyclic gear stage 102 of FIG. 4 is simplified for the purposes of this discussion so that unnecessary detail does not obscure the essential features of the invention. Furthermore, the skilled person would understand that the epicyclic gear stage 102 is simplified and, as such, a practical implementation would include more components that are specific to the particular application.

In the context of the invention, the epicyclic gear stage 102 is configured for use in a high load application as a speed increaser gear in a gearbox of a wind turbine generator, where at least two of these are coupled together. Skilled persons within gear technology will know of suitable ways to connect two or more epicyclic gear stages.

The components of the epicyclic gear stage 102 will be made out of suitable materials for high load applications. For example, the carrier 112 may be formed from a single piece of cast and machined iron. The material used for the planet and sun gears may be carburized steel, and the ring gear may be an alloy steel. The planet carrier 104 defines a number of fork structures 120, here three, each of which supports a respective planet gear 116.

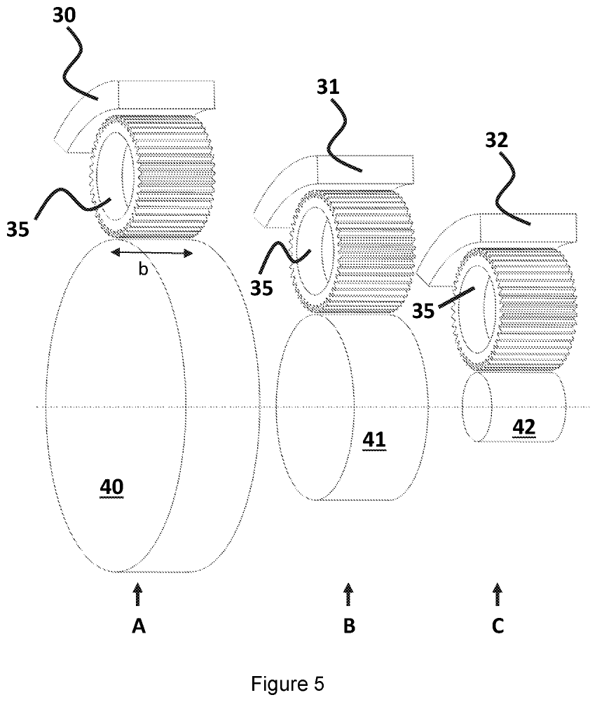

FIG. 5 is a perspective view of a first embodiment of the present invention. The figure shows three epicyclic gear stages, A, B, and C similar to the prior art shown in FIG. 3. The gear stages are shown very schematically to focus on the features important for embodiments of the present invention, and it should thus be understood that each gear stage will comprise a full ring gear, a sun gear, a planet carrier, and a number of planet gears, for example similar to FIG. 4.

The ring gears of the three stages are shown only partly and schematically with numerals 30, 31, 32. The sun gears of the three stages as well are shown only schematically with numerals 40, 41, 42. For simplification, no teeth are shown on the sun gears and ring gears. The sun gears are shown to have different diameters in the individual stages, thereby as in prior art facilitating how much torque the individual stages can handle through how many planet gears can be positioned circumferentially around it.

Only a single planet gear 35 is shown for each gear stage in FIG. 4, but it should be clear that any suitable number of planet gears can be distributed circumferentially around the individual sun gears, as circumferential space allows. For example, it is right away obvious that an example as described above for prior art could also work here with 18 planet gears in total, 9 in the first stage, 6 in the second stage and 3 in the last stage.

The planet gears 35 are here shown with spur gears for ease in the drawings. However, obviously the present invention is not limited to spur gears; in particular any helical angle of the planet gears would be equally suitable in the present invention, as long as all planet gears in the gearbox have equal gear profile design.

In the shown example of FIG. 5, the axial width of the sun gears and the axial width b of the planet gears are kept constant between the individual gear stages, with only the diameter of the sun gear varying (and the ring gears as well as required).

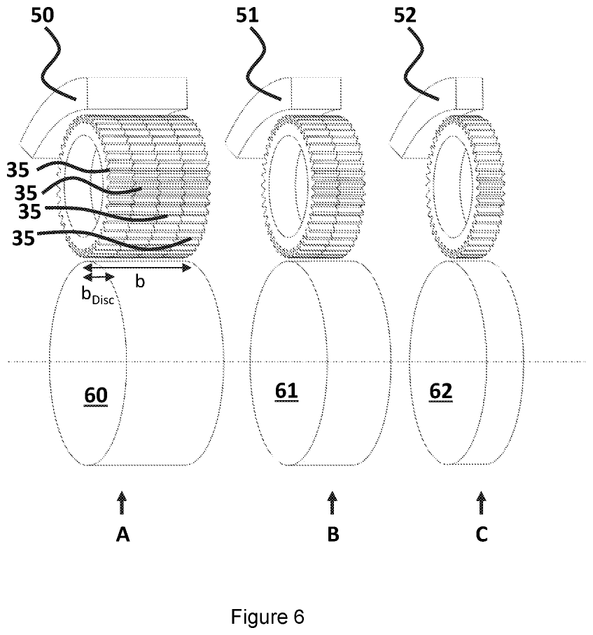

FIG. 6 is a perspective view of a second embodiment of the present invention. The figure shows three epicyclic gear stages, A, B, and C similar to FIG. 5. Again, the ring gears of the three stages are shown only partly and schematically, numerals 50, 51, 52. The sun gears of the three stages as well are shown only schematically with numerals 60, 61, 62. Again, for simplification, no teeth are shown on the sun gears and ring gears.

In this second embodiment, the sun gears are shown to keep their diameter constant between the stages, but instead the sun gears have different axial width from stage to stage thereby again facilitating how much torque the individual stages can handle.

In order to cope with this different torque between the stages, the ring gears also increase their axial width, but most importantly, the axial width b of the planet gears 35 is also increased. As shown in FIG. 6, this can be done by combining an integer number of individual planet gears each with individual axial width b_{Disc} into a combined and effective planet gear width b for each gear stage as required. Here is shown that in the first stage A each normal planet position comprises 4 individual planet gears, in the second stage B each normal planet position comprises 2 individual planet gears, and in the third stage C each planet position comprises 1 individual planet gear. Hereby the axial width of planet gears is shown as b, which is the sum of the axial widths of the individual planet gears, i.e. b=b_{Disc}*N, where N is the number of planet gears combined into a common planet gear.

It is worth noticing that in a design as in FIG. 6, it will thus be possible to vary both the number of planet gears distributed circumferentially around the sun gear in the individual stages as well as the number of planet gears stacked axially. Nonetheless, also in this embodiment, all individual planet gears of the gearbox are fully identical, not least having equal gear profile design.

In an embodiment not shown, but similar to FIG. 6, it is noted that instead of stacking individual planet gears to a desired width, varying the axial width of the planet gears used is also possible. As long as the gear profile design parameters is kept identical, such that it is only the axial width of the planet gears that is varied, the benefits of using the same tool for all planet gears is still achieved. Hence, for example in stage A, the width of the planet gears could be twice the width as the planet gears in stage B, which could be twice the width as the planet gears in stage C.

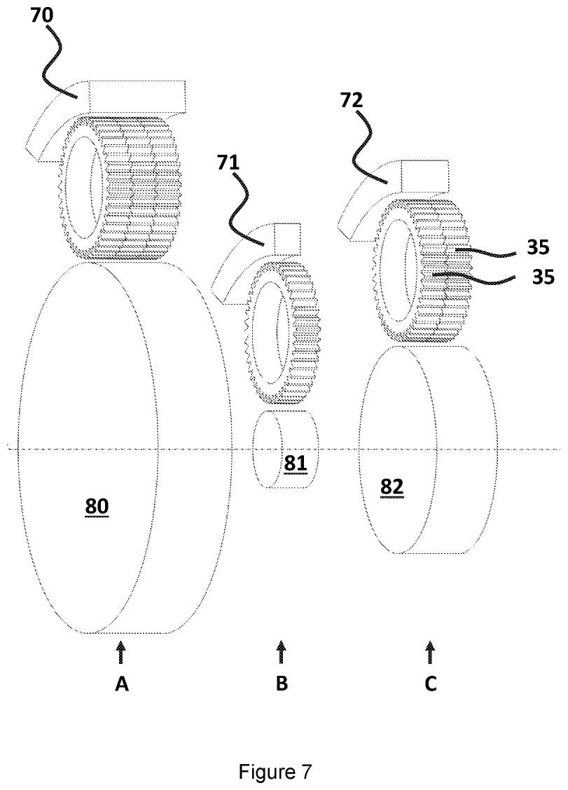

FIG. 7 is a perspective view of a third embodiment of the present invention, combining the previous embodiments. The figure shows three epicyclic gear stages, A, B, and C similar to FIGS. 5 and 6. Again, the ring gears of the three stages are shown only partly and schematically, numerals 70, 71, 72. The sun gears of the three stages as well are shown only schematically with numerals 80, 81, 82. Again, for simplification, no teeth are shown on the sun gears and ring gears.

The purpose of FIG. 7 is to illustrate that the invention should not be limited to specific orders of the individual sizes, numbers, etc. For instance it could be desired, as illustrated, to have a gear stage A with a large sun gear diameter and 3 planet gears on each planet position, followed by a gear stage B with a small sun gear diameter and 1 planet gear on each planet position, and finally a medium sun gear diameter with 2 planet gears on each planet position. Further, it is important to emphasize that the three stages shown in the examples here should not be limiting. The invention requires at least two epicyclic gear stages, but besides three stages, it could also be relevant with four or even more epicyclic stages.

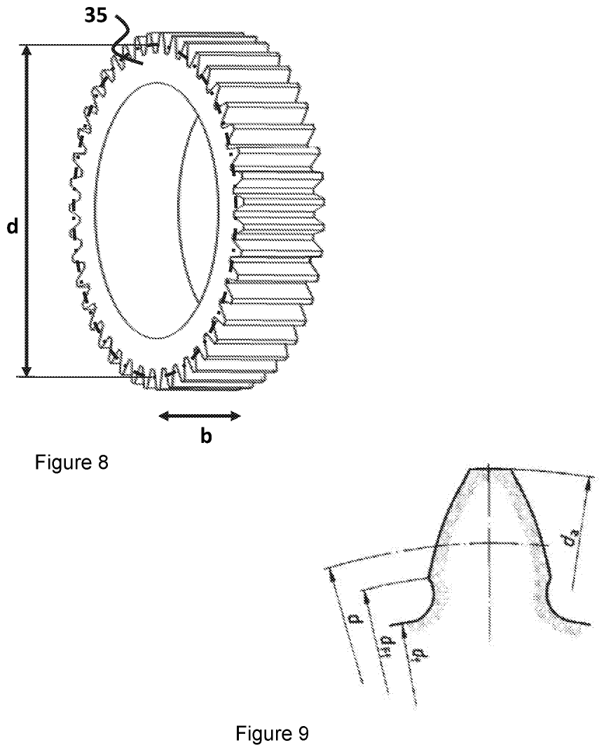

FIG. 8 shows a single planet gear 35, indicating the values b=axial width, and d=standard pitch diameter. As is known to the skilled person, d=z_{P}*mₙ/cos(ß), wherein mₙ is the normal module and ß is the angle compared to a spur gear. I.e. this formula is valid for both spur and helical gears. Typical values for ß are 0-30°.

FIG. 9 shows a single tooth of a planet gear in a cross-sectional view. Here is indicated some different diameters used by skilled persons, in particular the tip diameter, dₐ, the form diameter of dedendum, d_{Ff}, and the root diameter d_{f}. Further is shown a possible position of the standard pitch diameter d, even though, as mentioned above, this is a calculated value and not directly possible to measure on a gear.

Investigations have shown that for a planetary gear stage with a specific number of planets N a specific stationary gear ratio i_{0,max} exist which provides maximum torque density. This is important to ensure highest transmissible torque at lowest cost. For a gearbox series it is also important to reduce costs by using identical parts in a gearbox and over different gearbox sizes.

As experience shows that the use of identical parts normally is in contradiction to get the highest power density for a gearbox series compared to an individual point design of a gearbox the invention allows a combination of using identical parts and ensure highest torque density.

For all planetary gear stages within the scope of the present invention a quotient X may be calculated for the sum of the absolute tooth number of sun gear z_{S} and ring gear z_{RG} divided by the number of planet gears N. Once such value has been defined, it is preferable within the scope of the invention to use this quotient X as a constant for all epicyclic gear stages in a single gearbox, or even in a series of gearboxes. In one preferred embodiment the quotient X is (|z_{S}|+|z_{RG}|)/N=20. Alternative values of quotient X may be 18 or 22, or in general above 13, such as between 15 and 25.

With this the planets for each gear stage can be kept identical and at the same time this comes very close to the optimal stationary gear ratio for the highest torque density of a gear stage.

In embodiments, the number of planet gears in said at least first and said at least second epicyclic gear stage is different. For instance, the first stage may have at least one more planet gears than the second stage. Alternatively, the first stage may have at least two more planet gears than the second stage. Having different number of planet gears is believed to provide benefits in relation to vibrations.

The above description of identical planet gears also find use over different gearboxes. In particular for sets of wind turbines with different gearboxes, it is advantageous to still be able to use identical planet gears throughout, as described further herein.

The embodiments described above are merely examples of the invention defined by the claims that appear below. Those skilled in the design of wind turbines will appreciate additional examples, modifications, and advantages based on the description. In light of the above, the details of any particular embodiment should not be seen to necessarily limit the scope of the claims below.

1. A wind turbine, comprising:
a hub, a nacelle, a tower, and a power transmission system for increasing the rotational speed from said hub; said power transmission system comprising:
at least a first and a second epicyclic gear stage, each of said epicyclic gear stages including a ring gear, a planet carrier and a plurality of planet gears, said plurality of planet gears being mounted in the planet carrier and engaging with the ring gear and with a sun gear;
wherein each of said plurality of planet gears of at least said first epicyclic gear stage and said second epicyclic gear stage are identical in all of the following gear profile design parameters:
mₙ (normal module), αₙ (normal pressure angle), β (helix angle at pitch diameter), z_{P} (number of teeth), x (profile shift coefficient), x_{E} (generating profile shift coefficient), and h_{aP0}* (addendum coefficient factor of generating rack).

2. The wind turbine, comprising:
a hub, a nacelle, a tower, and a power transmission system for increasing the rotational speed from said hub; said power transmission system comprising:
at least a first and a second epicyclic gear stage, each of said epicyclic gear stages including a ring gear, a planet carrier and a plurality of planet gears, said plurality of planet gears being mounted in the planet carrier and engaging with the ring gear and with a sun gear;
wherein each of said plurality of planet gears of at least said first epicyclic gear stage and said second epicyclic gear stage are identical with respect to normal section profile, identical transverse section profile, and diameters.

3. The wind turbine according to claim 1, wherein each of said plurality of planet gears of said first epicyclic gear stage are identical in all parameters, and each of said plurality of planet gears of said second epicyclic gear stage are identical in all parameters, wherein the axial width of planet gears of said first epicyclic gear stage are different from the axial width of planet gears of said second epicyclic gear stage.

4. The wind turbine according to claim 1, wherein each of said plurality of planet gears of at least said first epicyclic gear stage and said second epicyclic gear stage are identical in all parameters.

5. The wind turbine according to claim 1, wherein all planet gears of each epicyclic gear stage has a ratio of b_{Disc}/d≤0.3.

6. The wind turbine according to claim 1, wherein the sun gear of said first epicyclic gear stage is different from the sun gear of said second epicyclic gear stage.

7. The wind turbine according to claim 1, wherein the sun gear of said first epicyclic gear stage is different from the sun gear of said second epicyclic gear stage by having a larger diameter.

8. The wind turbine according to claim 1 wherein the sun gear of said first epicyclic gear stage is different from the sun gear of said second epicyclic gear stage by having a larger axial width.

9. The wind turbine according to claim 1, wherein said power transmission system further comprises a third epicyclic gear stage including a ring gear, a planet carrier and a plurality of planet gears, said plurality of planet gears being mounted in the planet carrier and engaging with the ring gear and with a sun gear.

10. The wind turbine according to claim 9, wherein said power transmission system further comprises a fourth epicyclic gear stage including a ring gear, a planet carrier and a plurality of planet gears, said plurality of planet gears being mounted in the planet carrier and engaging with the ring gear and with a sun gear.

11. The wind turbine according to claim 1, wherein at least one of said epicyclic gear stages includes between 3 and 12 planet gears.

12. The wind turbine according to claim 1, wherein all planet gears in at least two gear stages comprises helical gears.

13. The wind turbine according to claim 1, wherein for said at least first and said at least second epicyclic gear stage the quotient X is the same, X being the sum of the absolute tooth number z_{S} of said sun gear and z_{RG} of said ring gear divided by the number of planet gears N in said epicyclic gear stage (X=(|z_{S}|+|z_{RG}|)/N).

14. The wind turbine according to claim 1, wherein the quotient X has a value between 13 and 33.

15. The wind turbine according to claim 1, wherein said number of planet gears in said at least first and said at least second epicyclic gear stage is different.

16. The wind turbine according to claim 1, wherein said number of planet gears in said at least first epicyclic gear stage is at least one higher than in said at least second epicyclic gear stage.

17. The wind turbine according to claim 1, wherein said number of planet gears in said at least first epicyclic gear stage is at least one higher than in said at least second epicyclic gear stage, and said number of planet gears in said at least second epicyclic gear stage is at least one higher than in a third epicyclic gear stage.

18. The wind turbine according to claim 1, wherein each of said epicyclic gear stages comprises at least 5 planet gears.

19. The wind turbine according to claim 1, wherein each of said plurality of planet gears of at least said first epicyclic gear stage and said second epicyclic gear stage has a number of gear teeth z_{P} between 20 and 40.

20. The wind turbine according to claim 1, further comprising:
a main shaft configured to be driven by the rotor about a main axis;
a support structure including at least one bearing supporting the main shaft for rotation about the main axis and constraining other movements;
wherein each of said epicyclic gear stages are part of a gearbox, wherein said gearbox has a gearbox housing rigidly coupled to the support structure and an input member coupled to the main shaft.

21. The wind turbine according to claim 20, wherein the support structure further includes a bearing housing surrounding the at least one bearing, the gearbox housing being suspended from the bearing housing.

22. The wind turbine according to claim 20, further comprising:
a generator having a rotor and stator positioned within a generator housing, the generator housing being rigidly coupled to and suspended from the gearbox housing.

23. The wind turbine according to claim 20, wherein the at least one bearing comprises a first bearing and a second bearing spaced apart within the bearing housing.

24. The wind turbine according to claim 20, wherein said planet carrier of said first epicyclic gear stage is connected to said main shaft.

25. The wind turbine according to claim 20, wherein a planet carrier of said second epicyclic gear stage is connected to said sun gear of said first epicyclic gear stage.

26. The wind turbine according to claim 20, wherein said gearbox is rigidly coupled to said support structure through a connection comprising:
a plurality of bolts installed in corresponding bolt holes of the gearbox and the support structure, and
a plurality of dowel pins installed in corresponding dowel pin holes of the gearbox and the support structure, the dowel pins having been installed in the dowel pin holes by shrink fitting.

27. The wind turbine according to claim 26, wherein the shrink fitting comprises cooling the dowel pins.

28. A set of wind turbines according to claim 1, comprising at least a first wind turbine with a first size gearbox and a second wind turbine with a second size gearbox, wherein said first size gearbox and said second size gearbox are different,
and wherein each of said planet gears of said first size gearbox and said second size gearbox are identical with respect to normal section profile, identical transverse section profile, and diameters.

29. The set of wind turbines according to claim 28 comprising at least 3 different gearbox sizes wherein each of said planet gears of said at least 3 different gearbox sizes are identical with respect to normal section profile, identical transverse section profile, and diameters.

30. The set of wind turbines according to claim 28, wherein said first size gearbox comprises at least 5 planet gears in said first epicyclic gear stage and at least 4 planet gears in said second epicyclic gear stage, and said second size gearbox comprises at least 6 planet gears in said first epicyclic gear stage and at least 5 planet gears in said second epicyclic gear stage.

31. The set of wind turbines according to claim 28, wherein each size of gearbox has at least 3 epicyclic gear stages (GP≥3).

32. The set of wind turbines according to claim 28, wherein each size of gearbox has at least 1 epicyclic gear stage (GP≥1) with at least 5 planet gears.
